(19) United States
(12) Patent Application Publication
(10) Pub. No.: US 2026/0158650 A1
(43) Pub. Date: Jun. 11, 2026

(54) METHOD AND APPARATUS WITH ROBOTIC CONTROL

(71) Applicant: Samsung Electronics Co., Ltd., Suwon-si (KR)

(72) Inventors: Younghwa JUNG, Suwon-si (KR); Woo Jung PARK, Suwon-si (KR)

(73) Assignee: Samsung Electronics Co., Ltd., Suwon-si (KR)

(21) Appl. No.: 19/200,038

(22) Filed: May 6, 2025

(30) Foreign Application Priority Data
Dec. 10, 2024 (KR) 10-2024-0182709

(51) Int. Cl. B25J 9/16

(52) U.S. Cl. CPC B25J 9/1664

(57) ABSTRACT

A processor-implemented method including detecting whether an electronic device is in a deadlock state, generating a plurality of candidate recovery poses for resolving the deadlock state by inputting pose information of the electronic device in the deadlock state to an artificial neural network model, generating a recovery pose distribution, the recovery pose distribution including respective probability information of each of the plurality of candidate recovery poses, determining a final recovery pose based on the recovery pose distribution, generating a control command of the electronic device based on the final recovery pose, and controlling the electronic device to resolve the deadlock state based on the control command.

### CROSS-REFERENCE TO RELATED APPLICATIONS

This application claims the benefit under 35 USC § 119 (a) of Korean Patent Application No. 10-2024-0182709, filed on Dec. 10, 2024, in the Korean Intellectual Property Office, the entire disclosure of which is incorporated herein by reference for all purposes.

### BACKGROUND

### 1. Field

The following description relates to a device and method with robotic control.

### 2. Description of Related Art

Robotics technology has become an important tool in contemporary industries and may be widely used in various fields, such as manufacturing, logistics, medical, and service industries. In particular, an end effector (or a work device), such as a robotic arm, may contribute to improving productivity through precise operations and high repeatability. Robotic arms may perform tasks such as moving or assembling objects, executing precise manipulations at specific points, and assisting with human tasks.

Robotic arms may include multiple joints and an end effector to implement various directions and postures. An operation of a robotic arm may be planned based on a given task goal and a complex control algorithm may be applied thereto to achieve a target position and pose. The control algorithm may be designed to operate each joint of the robotic arm in coordination with each other and this may allow the robotic arm to perform a precise task.

The robotic arm may collect environmental information through a sensor and may adjust its operation in real time based on the information. For example, a position of a task target may be identified using a camera or a distance sensor or the robotic arm's sensor may sense a physical interaction occurring during the task through a force sensor. This ability may enable the robotic arm to perform a task with high reliability even in a complex and dynamic work environment.

Robotic arms may perform multi-purpose tasks by being integrated with various task tools. For example, a gripper-type end effector may be attached to a robotic arm to grip an object or a welding device or a spraying device may be attached to a robotic arm to be used in a manufacturing process. As described above, robotic arms may be designed to perform various functions depending on the work environment and purpose.

However, robotic arm technology development does not simply include automating iterative tasks but also improving decision-making and task performance abilities in more complex environments. This further highlights the importance of the robotics technology in contemporary industries.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including detecting whether an electronic device is in a deadlock state, generating a plurality of candidate recovery poses for resolving the deadlock state by inputting pose information of the electronic device in the deadlock state to an artificial neural network model, generating a recovery pose distribution, the recovery pose distribution including respective probability information of each of the plurality of candidate recovery poses, determining a final recovery pose based on the recovery pose distribution, generating a control command of the electronic device based on the final recovery pose, and controlling the electronic device to resolve the deadlock state based on the control command.

The generating of the recovery pose distribution may include generating the recovery pose distribution by inputting the pose information of the electronic device and a task instruction to the artificial neural network model.

The determining of the final recovery pose may include inputting the recovery pose distribution to a sampler and selecting, by the sampler, a recovery pose with a highest probability from the plurality of candidate recovery poses according to the recovery pose distribution to be the final recovery pose.

The determining of the final recovery pose may include inputting the recovery pose distribution to a sampler and selecting, by the sampler, a recovery pose based on a preset condition to be the final recovery pose.

The determining of the final recovery pose may include, when the deadlock state is not resolved as a result of performing the final recovery pose, recording a failure count using a fallback counter.

The determining of the final recovery pose may include selecting the final recovery pose based on the recovery pose distribution and the failure count.

The artificial neural network model may include a model trained to generate the recovery pose distribution using the pose information of the electronic device in the deadlock state and a task instruction as inputs.

The artificial neural network model may be based on a conditional neural process (CNP) configured to calculate a probability distribution of multivariate Gaussian processes (MGPs).

The detecting of whether the electronic device is in the deadlock state may include determining whether the electronic device is in the deadlock state based on detecting one of an operation constraint of the electronic device and a preset task constraint.

The operation constraint may include one or more of a first case in which a force applied to a driving part of the electronic device exceeds a first preset limit, a second case in which an operating range of the electronic device exceeds a first preset limit, and a third case in which the electronic device fails to move to a predicted position within a tolerance limit and the preset task constraint includes a fourth case in which an operation of the electronic device violates a predetermined safety constraint and a fifth case in which a task execution time exceeds a preset maximum time.

The pose information of the electronic device may include 6 degrees of freedom (DoF) pose information of the electronic device and a position, a direction, and a rotational axis of an end effector of the electronic device.

In a general aspect, here is provided an electronic device including processors configured to execute instructions, a memory storing the instructions, and an execution of the instructions configures the processors to detect whether the electronic device is in a deadlock state, generate a plurality of candidate recovery poses for resolving the deadlock state by inputting pose information of the electronic device in the deadlock state to an artificial neural network model, generate a recovery pose distribution, the recovery pose distribution including respective probability information of each of the plurality of candidate recovery poses, determine a final recovery pose based on the recovery pose distribution, generate a control command of the electronic device based on the final recovery pose, and control the electronic device to resolve the deadlock state based on the control command.

The processors may be further configured to generate the recovery pose distribution by inputting the pose information of the electronic device and a task instruction to the artificial neural network model.

The processors may be further configured to input select a recovery pose with a highest probability from the plurality of candidate recovery poses according to the recovery pose distribution to be the final recovery pose.

The processors may be further configured to, when the deadlock state is not resolved as a result of performing the final recovery pose, record a failure count.

The processors may be further configured to select the final recovery pose based on the recovery pose distribution and the failure count.

The artificial neural network model may include a model trained to generate the recovery pose distribution using the pose information of the electronic device in the deadlock state and a task instruction as inputs.

The processors may be further configured to determine whether the electronic device is in the deadlock state based on detecting one of an operation constraint of the electronic device and a preset task constraint.

The operation constraint may include one or more of a first case in which a force applied to a driving part of the electronic device exceeds a first preset limit, a second case in which an operating range of the electronic device exceeds a first preset limit, and a third case in which the electronic device fails to move to a predicted position within a tolerance limit and the preset task constraint may include a fourth case in which an operation of the electronic device violates a predetermined safety constraint and a fifth case in which a task execution time exceeds a preset maximum time.

The electronic device may be a robotic arm and the pose information of the electronic device may include 6 degrees of freedom (DoF) pose information of the robotic arm and a position, a direction, and a rotational axis of an end effector of the robotic arm.

Other features and aspects will be apparent from the following detailed description, the drawings, and the claims.

### BRIEF DESCRIPTION OF THE DRAWINGS

FIG. 1 illustrates an example electronic device according to one or more embodiments.

FIG. 2A illustrates an example method with a robotic arm according to one or more embodiments.

FIG. 2B illustrates an example next pose predictor according to one or more embodiments.

FIG. 3 illustrates example a robotic arm in a deadlock state according to one or more embodiments.

FIG. 4 illustrates an example method of an electronic device according to one or more embodiments.

FIG. 5 illustrates an example algorithm for an operation process of a failure detector according to one or more embodiments.

FIG. 6 illustrates an example method with a recovery pose distribution estimator according to one or more embodiments.

FIG. 7 illustrates an example method of generating training data with a next pose predictor and a recovery pose distribution estimator according to one or more embodiments.

FIGS. 8A and 8B illustrate example methods with a next pose predictor and a recovery pose distribution estimator, respectively, according to one or more embodiments.

FIG. 9 illustrates an example method of training a recovery pose distribution estimator according to one or more embodiments.

FIG. 10 illustrates an example trained recovery pose estimator according to one or more embodiments.

FIG. 11 illustrates an example method with an electronic device according to one or more embodiments.

FIG. 12 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

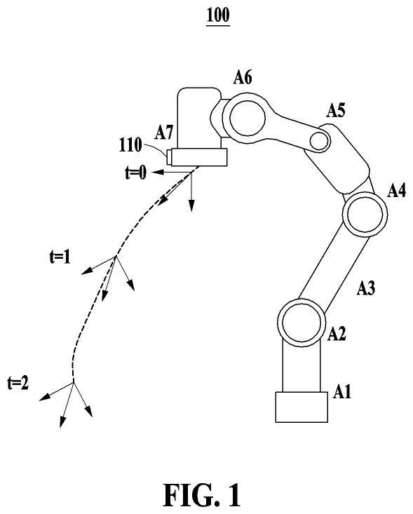

FIG. 1 illustrates an example electronic device according to one or more embodiments.

Referring to FIG. 1, in a non-limiting example, a robotic arm 100 may include various joints A1, A2, A3, A4, A5, and A6 and an end effector 110. While the robotic arm 100 is described as a representative example of the electronic device, examples of the electronic device are not limited to the robotic arm 100 and may apply to various electronic devices, for example, an industrial automation device, a medical robot, or a logistics robot.

In an example, the robotic arm 100 may include various joints A1, A2, A3, A4, A5, and A6 and an end effector 110. The end effector 110 may be positioned at an end portion of the robotic arm and may be a portion including a work tool or a sensor. The end effector 110 may serve to directly contact a task target or perform a task. For example, the end effector 110 may include a gripper, a welder, or a sensor, such as a camera.

In an example, the end effector 110 may be in different positions at different time points t=0, t=1, and t=2. The position change may be achieved by predicting a next pose of the end effector by a pose predictor. The predicted next pose may be used to determine a direction and an angle of each of the joints A1, A2, A3, A4, A5, and A6 of the robotic arm to move. In this case, the respective motions for each of the joints may be calculated by inverse kinematics based on a traditional optimization theory.

The calculated joint motion may be transmitted to each joint through a controller to enable the joints to move into the predicted pose. By iteratively performing this process, the robotic arm 100 may complete a task instruction. For example, the task instruction may correspond to assembling a specific workpiece, moving an object, or performing a precision task.

As described further below, example methods and devices may predict and implement a recovery pose to resolve a deadlock state and properly perform a task when the electronic device is in the deadlock state. During this process, the definition of the deadlock state, prediction of the recovery pose, calculation of a joint motion based on inverse kinematics, and a role of a controller may be important factors.

In an example, the deadlock state may be a state in which the robotic arm 100 is unable to perform an intended task or a motion of the robotic arm 100 is restricted. The deadlock state may occur when the end effector 110 stops at a specific position or is unable to perform a task. For example, there may be a scenario in which the robotic arm is blocked by an obstacle in a specific task area or another example scenario in which the robotic arm is unable to reach a target position due to a system failure, and these scenarios may correspond to deadlock states.

In an example, the recovery pose may indicate a pose that the robotic arm 100 needs to adopt to resolve the deadlock state. The recovery pose may vary depending on a current state and surrounding environment of the electronic device. For example, when the end effector 110 is blocked by an obstacle, the recovery pose may include a direction and magnitude of the end effector to move to escape from the obstacle.

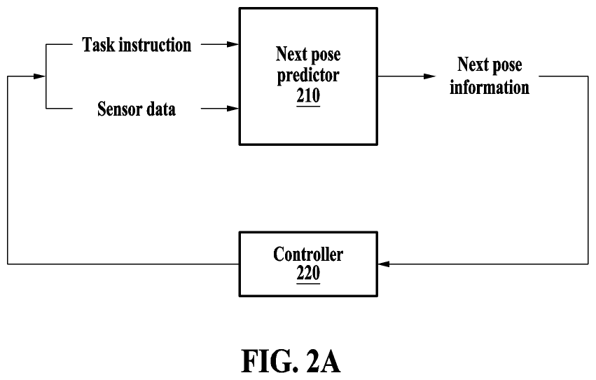

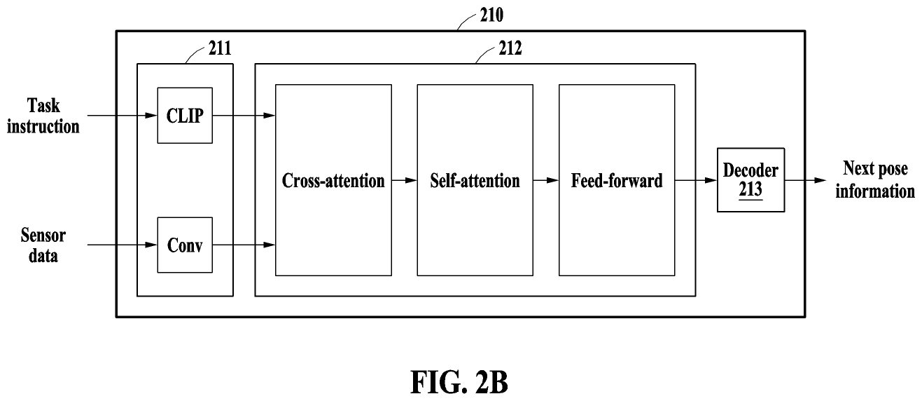

FIG. 2A illustrates an example method with a robotic arm according to one or more embodiments. The description provided with reference to FIG. 1 may apply to FIG. 2A.

Referring to FIG. 2A, in a non-limiting example, an electronic device (e.g., the robotic arm 100 of FIG. 1) may predict a next pose based on a task instruction and sensor data and may control operations of the electronic device through this information. The electronic device may include a next pose predictor 210 and a controller 220.

In an example, the task instruction may be an instruction that defines a goal to be performed by the electronic device and may be provided in the form of text or code. For example, a task instruction “pick up a box and move the box to the right platform” may indicate a specific action that an end effector needs to perform. The task instruction may be provided to the next pose predictor 210 as an input.

In an example, the sensor data may be information indicating states of the electronic device and surrounding environments and may be collected by a camera, a red-green-blue depth (RGBD) sensor, and a force sensor. For example, a position and a size of a task target may be identified by the camera or a physical interaction between the end effector and the task target may be measured by the force sensor. The sensor data may be used as an input to the next pose predictor 210 and may be combined with the task instruction to predict a next pose of the end effector.

In an example, the next pose predictor 210 may serve to calculate the next pose of the end effector, based on the input task instruction and the sensor data. The next pose information may define a pose and a position to which the end effector needs to move and the electronic device may include information required to determine an operation that each joint of the electronic device needs to perform. The next pose predictor may be referred to as a next-base-pose (NBP) predictor.

In an example, the next pose information may be transmitted to the controller 220. The controller 220 may control an operation of the electronic device based on the next pose information. The controller may calculate a direction and angle that each joint needs to move using the inverse kinematics algorithm and may move the electronic device or a specific component of the electronic device to a desired position based thereon.

FIG. 2B illustrates an example next pose predictor according to one or more embodiments. The description provided with reference to FIGS. 1 and 2A may apply to FIG. 2B.

Referring to FIG. 2B, in a non-limiting example, the next pose predictor 210 may include an encoder 211, a transformer network 212, and a decoder 213. The encoder 211 may extract a feature by processing input data.

In an example, the task instruction may be input to a contrastive language-image pretraining (CLIP) model and the CLIP model may extract a linguistic feature of the task instruction. For example, the task instruction “move a box to the right” may be converted into a vectorized linguistic feature through the CLIP model.

In an example, the sensor data may be processed using a convolution-based feature extractor. For example, a feature may be extracted from image data collected by the camera through a convolutional neural network (CNN) and state data of a robotic joint may be integrated with the sensor data and may be processed by the same extractor.

In an example, the transformer network 212 may generate an integrated feature required to predict a next pose by integrating features extracted by the encoder. The transformer network 212 may include a cross-attention layer, a self-attention layer, and a feed-forward layer. The cross-attention may learn an interaction between a task instruction and the sensor data and the self-attention may be used to analyze the correlation within the sensor data. The integrated feature through this process may be transmitted to the decoder.

In an example, the decoder 213 may generate next pose information based on the integrated feature generated by the transformer network 212. The next pose information may define a target position and a target direction of the end effector and through this, may calculate a joint action of the robotic arm.

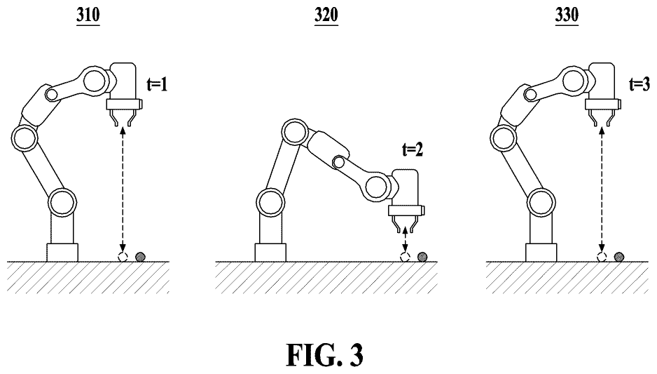

FIG. 3 illustrates example a robotic arm in a deadlock state according to one or more embodiments. The description provided with reference to FIGS. 1 to 2B may apply to FIG. 3.

Referring to FIG. 3, in a non-limiting example, diagrams 310, 320, and 330 may show operations iteratively performed by a robotic arm along a time t axis, respectively. More specifically, diagram 310 may show a state in which the robotic arm performs an initial operation. In this state, an end effector of the robotic arm may decline to grip a task target (e.g., an object) at a specific position. For example, when the robotic arm uses a gripper to grip an object, the end effector may not accurately grip the object or the object may not be located at an expected position.

Diagram 320 may show a state in which the robotic arm tries the same operation again. Even though the initial operation fails, the robotic arm may try the task again by repeating the same pose and path. During this process, a possibility that the robotic arm reaches a deadlock state may increase. For example, the deadlock state may indicate a state in which the robotic arm is unable to escape from a specific condition and repeats the same operation at the same position. The state from which the robotic arm cannot escape may be a main cause of the robotic arm failing to complete the given task.

Diagram 330 may show a state in which the robotic arm is still in the deadlock state and repeats the same operation. Even in this stage, the robotic arm may try an operation to grip the object, but may not succeed due to an environmental constraint or an operation constraint of the robotic arm. The iterative operation described above may significantly deteriorate the work efficiency of the robotic arm and may also degrade the stability and reliability of the system.

To resolve the problem, a process for the robotic arm to recognize the deadlock state and estimate and apply a new pose, in other words, a recovery pose, to escape from the deadlock state may be required. The recovery pose may be designed to allow the end effector to find a new path or take a different task pose. For example, the robotic arm may elevate the end effector to escape from the deadlock state or may move the end effector in a different direction.

In a typical robot control system, when the given task has failed, there are limitations in that the conventional robot control system may not effectively perform an alternative process (fallback loop) or may repeat the same operation without recognizing the deadlock state. To overcome the limitations, example robotic arms may recognize the deadlock state in real time, predict a recovery pose, and convert the recovery pose into a control instruction. This example process may contribute to helping the robotic arm escape from the deadlock state and successfully complete the task.

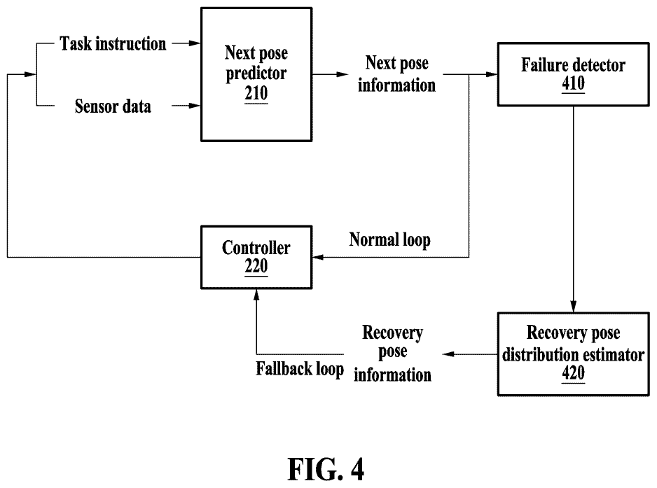

FIG. 4 illustrates an example method of an electronic device according to one or more embodiments. The description provided with reference to FIGS. 1 to 3 may apply to FIG. 4.

Referring to FIG. 4, in a non-limiting example, an electronic device (e.g., robotic arm 100) may also perform a fallback loop including a failure detector 410 and a recovery pose distribution estimator 420 to resolve a problem of reaching a deadlock state while performing a given task. This may allow the electronic device to escape from the deadlock state and continue to perform the task.

In an example, the electronic device may include the next pose estimator 210, the controller 220, the failure detector 410, and the recovery pose distribution estimator 420. However, not all components illustrated in the drawings may be included. For example, the electronic device may be implemented by more components than the illustrated components or the electronic device may be implemented by fewer components.

In an example, an operation process of the electronic device may be divided into a normal loop and a fallback loop. For example, the robotic arm may perform a task through the normal loop and when a deadlock state occurs during the task, the failure detector 410 may detect the deadlock and may switch to the fallback loop. The recovery pose distribution estimator 420 may predict a recovery pose and may transmit the recovery pose to the controller 220 and the robotic arm may escape from the deadlock state and may resume the task. The structure described above may support the robotic arm to perform the task more reliably and flexibly.

In an example, the normal loop may be a default operation process in which an electronic device (e.g., a robotic arm) calculates a next pose using the next pose predictor 210 based on the task instruction and the sensor data and performs a task by controlling a joint of the robotic arm through the controller 220. For example, the task that the robotic arm grips an object and moves the object to another position may be performed through the normal loop.

In an example, the fallback loop may be an exception processing process that is triggered when the deadlock state occurs in the normal loop. The failure detector 410 may determine the deadlock state and may predict a recovery pose for escaping from the deadlock state through the recovery pose distribution estimator 420. Thereafter, the controller 220 may move the robotic arm to a new pose using the recovery pose information and may return to the normal loop to resume the task.

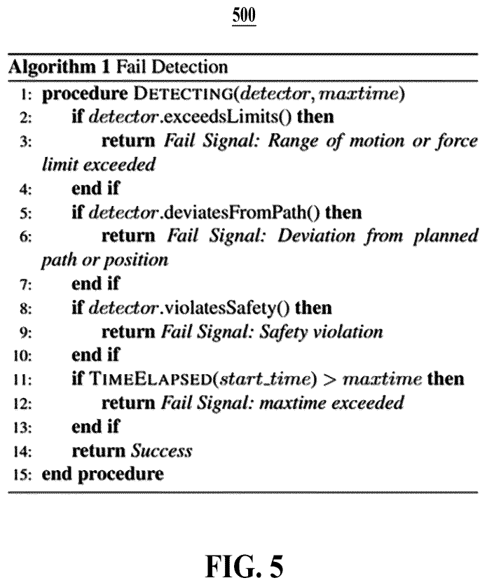

In an example, the failure detector 410 may determine whether the electronic device is in the deadlock state. The failure detector may analyze a current state of the electronic device, the task instruction, and the sensor data to determine whether the task is successful. For example, the deadlock state may be determined to be a case in which the robotic arm fails to grip an object at a position designated by the task instruction or fails to complete the task within an allowed time. In such cases, the failure detector may transmit information related to the deadlock state to the recovery pose distribution estimator 420 to calculate the recovery pose. An operating method of the failure detector 410 is described in greater detail below with reference to FIG. 5.

In an example, the recovery pose distribution estimator 420 may predict a recovery pose for the robotic arm to escape from the deadlock state. The recovery pose may indicate a position and a direction that the electronic device needs to adopt to resolve the deadlock state and resume the task. The recovery pose distribution estimator may generate a conditional probability distribution (conditional distribution) based on the current deadlock state and the task instruction. The conditional probability distribution may indicate multiple candidate poses for escaping from the deadlock state and a model may select a recovery pose with the highest probability.

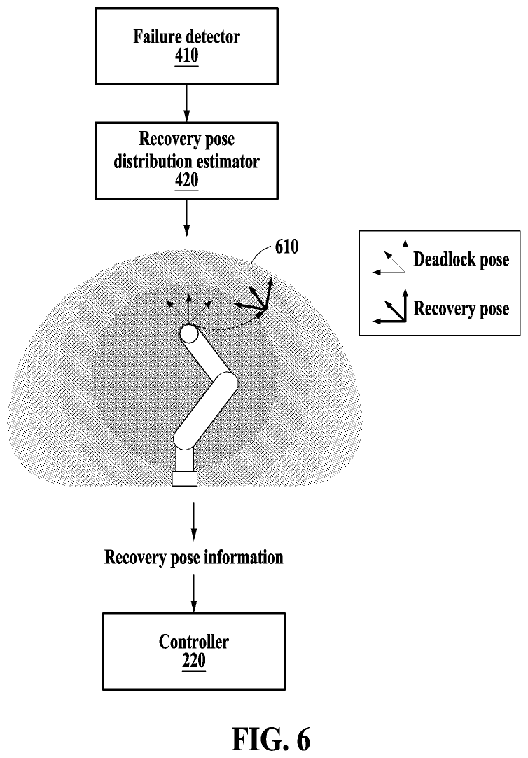

For example, when the robotic arm fails to escape from a position of a specific task target and/or fails to perform an iterative operation, the recovery pose distribution estimator may propose the recovery pose to elevate the end effector of the robotic arm or move the end effector of the robotic arm in a new direction. The calculated pose information may be executed by the controller 220 and the robotic arm may escape from the deadlock state and may return to the normal loop. An operating method of the recovery pose distribution estimator 420 is further described in greater detail below with reference to FIG. 6.

FIG. 5 illustrates an example algorithm for an operation process of a failure detector according to one or more embodiments. The description provided with reference to FIGS. 1 to 4 may apply to FIG. 5.

Referring to FIG. 5, in a non-limiting example, a failure detector (e.g., the failure detector 410 of FIG. 4) may employ an algorithm 500 which may apply various rules to detect a situation in which an end effector is unable to properly perform a task in advance and recognize a deadlock state. An algorithm (e.g., algorithm 500) may assess failure conditions that may occur during execution and may include general rules depending on work environments and rules optimized for a specific task.

For example, in Line 1 of the algorithm 500 an initial setting step is illustrated. The algorithm 500 may begin with a detecting (detector, maxtime) procedure. The detector may include a sensor for assessing a current state and an operation of the end effector and maxtime may indicate a maximum execution time of each task step. The maxtime may be set based on training data. For example, the maxtime may be determined based on an average execution time of multiple demo runs conducted in a given task.

Lines 2 to 4 of algorithm 500 may represent an operation range exceeding detection step. A detector.exceedsLimits( ) function may identify whether a force applied to a joint of the end effector or an operation range exceeds a preset limit. For example, when the robotic arm moves to a specific position to grip an object and a motion of the joint exceeds a mechanical limit or an abnormally great force is applied to the robotic arm or the joint, it may be determined to be a failure. In this case, the algorithm may return “Fail Signal: Range of motion or force limit exceeded”.

Lines 5 to 7 of algorithm 500 may represent a predicted path deviation detection step. A detector.deviatesFromPath( ) function may determine whether the end effector of the end effector deviates from a predicted position or a planned path. For example, when the robotic arm deviates from an expected position by 1 cm or more to grip an object, it may be considered that the robotic arm is out of tolerance from the predicted position or planned path. In this case, the algorithm may return “Fail Signal: Deviation from planned path or position”.

Lines 8 to 10 of algorithm 500 may represent a safety constraint violation detection step. A detector.violatesSafety( ) function may determine whether the end effector violates preset safety constraints. For example, when the robotic arm collides with a surrounding obstacle in the work environment or deviates from a safe zone set by a user, it may be considered a failure. In this case, the algorithm may return “Fail Signal: Safety violation”.

Lines 11 to 13 of algorithm 500 may represent a maximum time exceeding the detection step. A TIMEELAPSED(start_time)>maxtime condition may determine whether the end effector performs the task while exceeding a designated maxtime. The maxtime may be set based on an average execution time of a specific task. For example, when the average execution time of a task of gripping and moving an object is 10 seconds, the maxtime may be set to 15 seconds. When the condition is exceeded, “Fail Signal: maxtime exceeded” may be returned.

Lines 14 and 15 of algorithm 500 may represent a normal termination step. When all of the above conditions are not satisfied, the algorithm may return “Success” and this may indicate that the end effector operates normally.

The failure detector may be a core processing element for assessing a state of the end effector and the deadlock state and may detect whether the task has failed based on various conditions. A first condition may be the exceedance of an operation range of the end effector and may determine whether a motion of a joint or a force applied to the joint exceeds a preset limit. For example, when an excessive force is applied to the robotic arm or the robotic arm is out of the operation range while the robotic arm attempts to move to a specific position, it may be determined to be a failure. A second condition may be path deviation and may include a case in which the end effector of the end effector deviates from a planned path or fails to reach a predicted position. For example, a case in which when the robotic arm attempts to grip an object based on a task instruction, the end effector is out of tolerance from a target position may correspond to this condition.

In addition, the failure detector may assess the violation of a safety constraint in the work environment. The safety constraint may be defined to prevent a collision with an obstacle during the operation of the end effector or to maintain a safe zone in a workspace. For example, when the robotic arm collides with an obstacle during the task or violates a preset safety condition, it may be considered a failure. Lastly, the failure detector may also detect whether a task execution time exceeds a set maximum time. When the operation of the end effector exceeds the predefined maximum execution time (maxtime), the failure detector may determine that the task has failed. The maxtime may be calculated based on the training data with respect to the given task and, for example, may be set to a value obtained by adding a marginal value to an average execution time of a task of gripping and moving an object.

For example, the failure detector may determine the deadlock state to be a case in which while the robotic arm performs a task of picking up a box, one of the following scenarios occurs including an excessive force is applied to the joint, the robotic arm deviates from a task path, collides with a surrounding obstacle, or the task execution time exceeds 15 seconds. When the deadlock state occurs, the robotic arm may resolve the problem by immediately switching to a fallback loop for estimating the recovery pose. The failure detector may operate based on various conditions described above and may play a key role in improving the safety and efficiency of the end effector.

However, in an example, the failure detector may perform other methods other than the rule-based conditions described above. For example, when the failure detector is implemented based on an artificial neural network model, the failure detector may determine the deadlock state by learning the data on the work environment and the state of the end effector. The neural network-based failure detector may analyze an operation pattern of the end effector and an environmental change more precisely and may detect the deadlock state in real-time even in a complex situation.

Specifically, the artificial neural network model may predict whether the task is properly performed or that the possibility of failure is high by receiving operational data of the end effector, the state of the joint, and the sensor as inputs. For example, before a situation in which the end effector deviates from a given path or exceeds a limit, the artificial neural network model may detect the situation in advance and may output a warning signal or may determine that the deadlock state has occurred. This neural network-based approach may overcome the limitation of typical rule-based schemes and may provide high reliability and accuracy even in a more complex and dynamic work environment.

As a result, the failure detector may be designed as a flexible module that is able to effectively determine the deadlock state in various environments through not only the rule-based algorithm but also an intelligent approach such as employing an artificial neural network model.

FIG. 6 illustrates an example method with a recovery pose distribution estimator according to one or more embodiments. The description provided with reference to FIGS. 1 to 5 may apply to FIG. 6.

Referring to FIG. 6, in a non-limiting example, the recovery pose distribution estimator 420 may receive an indication of a deadlock pose from the failure detector 410 and may estimate a recovery pose for escaping from the current deadlock state. The recovery pose may be represented as a pose having 6 degrees of freedom (DoF). In this case, 6 DoF may be a total of 6 degrees of freedom including x, y, z coordinates indicating the position of the end effector of the robotic arm and roll, pitch, and yaw indicating a rotation state. However, the method of representing the recovery pose is not limited thereto.

In an example, the recovery pose distribution estimator 420 may represent multiple recovery poses with possibilities of the end effector to escape from the current state in the form of a probability distribution, based on the input deadlock pose. In a diagram 610, a higher probability of escaping from the current deadlock state is illustrated in a darker color than surrounding colors of alternative possibilities of escaping illustrated in diagram 610. The probability distribution may numerically represent the possibility of a specific pose for resolving the deadlock state and may support the robotic arm to operate in a more optimized manner.

For example, when the robotic arm is in the deadlock state and repeats the same operation while attempting to grip an object, the recovery pose distribution estimator 420 may move the end effector to a new position or may propose a new pose to rotate to in a direction that enables the robotic arm to escape from the current pose. The recovery pose may be computed based on a conditional probability distribution designed to escape from the deadlock state. A pose with the highest probability in the distribution may be determined to be the recovery pose and this may be performed by the controller 220.

The controller 220 may receive the recovery pose as an input and may calculate a motion of each joint through the inverse kinematics algorithm. Through this, a direction and an angle through which each joint of the robotic arm may move through to move to the estimated recovery pose may be determined and then the end effector may move to the estimated recovery pose. Thereafter, the robotic arm may return to the normal loop and may resume the original task.

For example, it may be assumed that the robotic arm is in the deadlock state because the robotic arm failed to accurately detect a position of an object while attempting to grip the object. In this case, the recovery pose distribution estimator 420 may propose a pose for finding a new approach path by moving the end effector slightly upward or laterally. Through the recovery pose, the robotic arm may escape from the deadlock state and may resume the task.

In an example, the recovery pose distribution estimator 420 may provide flexibility to find various recovery poses based on the probability distribution, unlike typical simple rule-based schemes. Through this, the electronic device may maintain high reliability and stability in a more complex work environment and may effectively resolve the deadlock state.

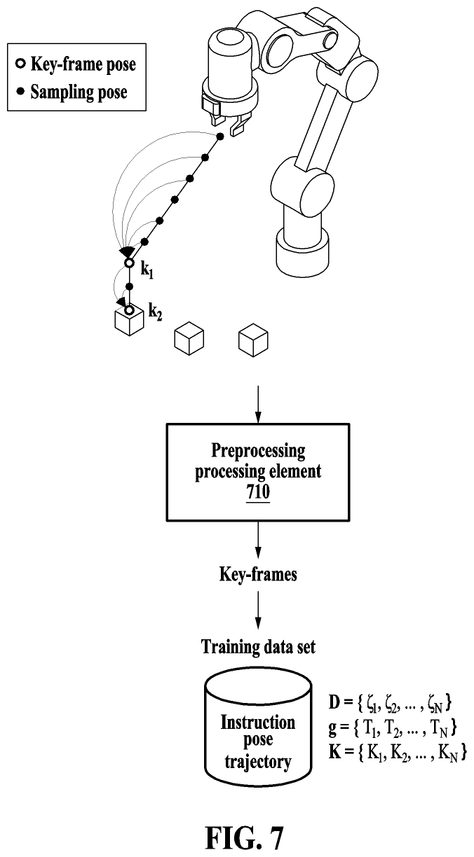

FIG. 7 illustrates an example method of generating training data with a next pose predictor and a recovery pose distribution estimator according to one or more embodiments. The description provided with reference to FIGS. 1 to 6 may apply to FIG. 7.

In an example, the above described neural network-based approach, training data may be constructed based on a task instruction that defines a task of a robotic arm and a demonstration of an expert performing the same. The task instruction [symbol] may be defined in the form of text and for example, may be represented as an instruction such as “grip the green cube”. The demonstration ζi={s₀, a₀, . . . , s_{T}, a_{T}} may include a state sₜ and an action aₜ of an end effector of the robotic arm at each time step. The state sₜ may include observation data obtained from a sensor and for example, may be defined as information collected by a camera or a force sensor. The action at may indicate a pose of the end effector and may include information, such as a pose aₚₒₛₑ, an open/close state of the end effector aₒₚₑₙ, and a collision state a_{collide}.

The use of data obtained at all time steps for training may be inefficient. This is because training a neural network with a relationship between the task instruction and all actions is complex and as the task becomes more complex, the training difficulty may exponentially increase. Accordingly, a key frame that indicates only an essential operation for performing the task may be selected and may be used as the training data.

In an example, the key frame may be defined as a frame that satisfies a predetermined condition. For example, the key frame may be defined as an action that simultaneously satisfies the following two conditions. The first condition may be a case in which the velocity of a joint value of the robotic arm is close to “0”, and the case may indicate that the robotic arm completes a specific operation and stops. The second condition may be a case in which the open/close state of the end effector is unchanged, and the case may indicate that the robotic arm maintains the current state. Selecting actions satisfying the conditions described above to be the key frames may improve the efficiency of the training data and may support the neural network to effectively learn the relationship between the task instruction and the action.

Referring to FIG. 7, in a non-limiting example, the task instruction and demonstration data may be processed by a preprocessing processing element 710 and may be configured as a key frame set Kᵢ={k₁, k₂, . . . kₙ_{ᵢ}}. In this process, the task instruction and a corresponding key frame set may be paired and a training data set [symbol] ={ [symbol] , ζ₁, K₁, . . . , [symbol] , ζ_{N}, K_{N}} may be generated through various task instructions and data on multiple demonstrations according to the task instructions. The training data set may be used for the training of the next pose predictor and the recovery pose distribution estimator.

For example, when the robotic arm performs a task of gripping a green cube, the task instruction may be defined as “grip the green cube” and the demonstration data may include states and actions of the robotic arm while the robotic arm moves toward the cube, grips the cube, and moves again. In this process, the key frame may be constituted by the data representing a state of the robotic arm in which the robotic arm accurately grips the cube or stops after gripping the cube. The constituted training data may be used for the robotic arm to predict a next operation based on the task instruction or estimate a recovery pose in a deadlock state.

The data generation process described with reference to FIG. 7 may contribute to building a data set for maximizing training efficiency and providing high reliability and performance even in a complex work environment.

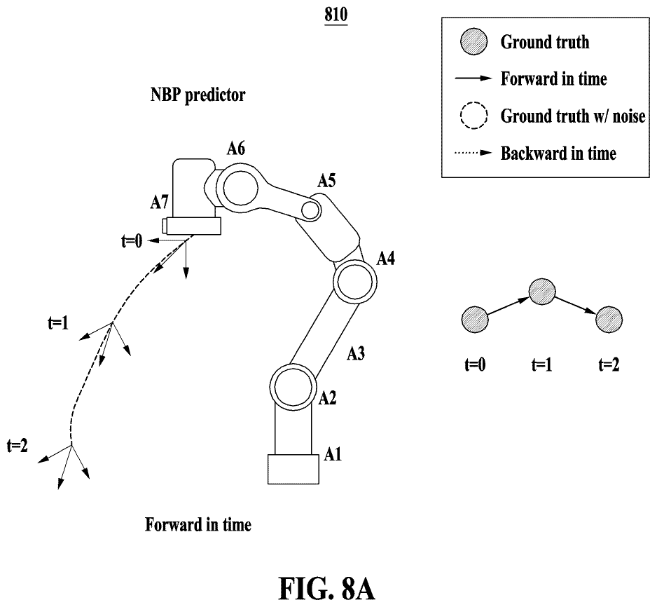

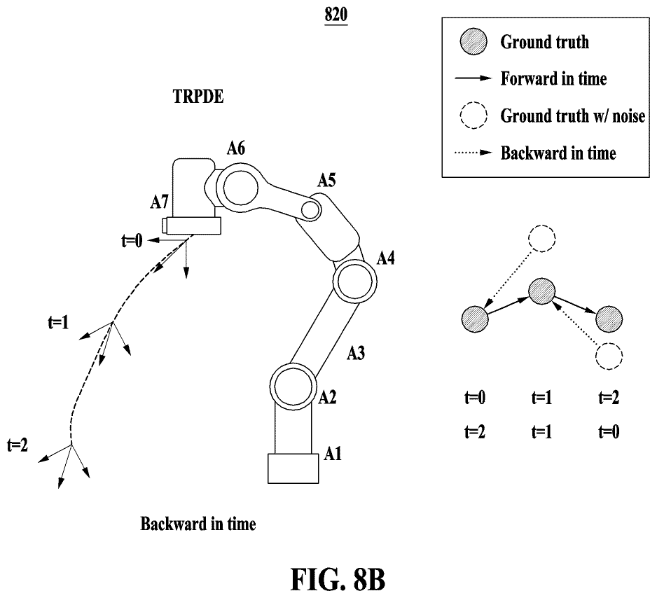

FIGS. 8A and 8B illustrate example methods with a next pose predictor and a recovery pose distribution estimator, respectively, according to one or more embodiments. The description provided with reference to FIGS. 1 to 7 may apply to FIGS. 8A and 8B.

Referring to FIG. 8A, in a non-limiting example, a next pose predictor (e.g., the next pose predictor 210) may predict a next pose for an end effector of an electronic device to move in chronological order to perform a given task. To train this, data collected by the end effector during the task may be used. In a diagram 810, a motion of the end effector may be divided into time steps, such as t=0, t=1, and t=2 and in each time step, a pose of the end effector may be shown as a dot. For example, at t=0, the end effector may be at an initial position and as proceeding to t=1 and t=2, the end effector may move to perform the task.

The training of the next pose predictor may be performed in chronological order. The training may be performed to reduce an error by comparing a pose (ground truth) that the end effector actually performs with a predicted pose in the next step. For example, the training may be performed to minimize a difference between an actual pose that the end effector moves at t=1 and a predicted pose for that time step. As described above, the next pose predictor may be trained to accurately predict a next pose required for the end effector to perform the given task.

Referring to FIG. 8B, in a non-limiting example, process of training a recovery pose distribution estimator (e.g., recovery pose distribution estimator 420) is illustrated. The recovery pose distribution estimator may be used to estimate a recovery pose for escaping a deadlock state when the end effector is in the deadlock state. In an example, to train the recovery pose distribution estimator, data of the end effector may be used in reverse chronological order. For example, the data may be used for training in the order of t=2, t=1, and t=0, and a pose of the end effector in the deadlock state at t=2 may be assumed. For this, noise may be added to a current pose (e.g., t=2) to create a state close to the deadlock state to be used for training. The added noise during this process may be shown as a dotted circle in the right figure of a diagram 820.

The recovery pose distribution estimator may be trained to output a recovery pose in a previous step by receiving observation data related to a current deadlock state pose as an input. For example, the recovery pose distribution estimator may receive the deadlock state pose at t=2 as an input and may predict a recovery pose at t=1. As described above, the recovery pose distribution estimator may learn an optimal recovery pose for escaping from various deadlock states using the reverse chronological data.

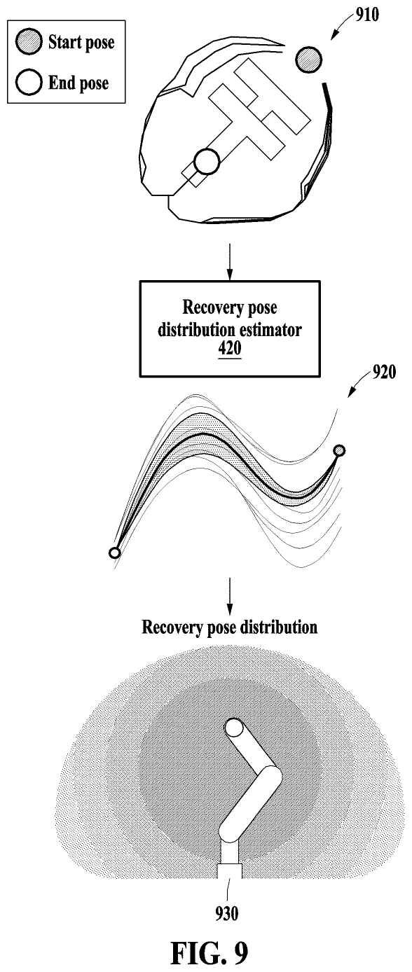

FIG. 9 illustrates an example method of training a recovery pose distribution estimator according to one or more embodiments. The description provided with reference to FIGS. 1 to 8B may apply to FIG. 9.

Referring to FIG. 9, in a non-limiting example, the recovery pose distribution estimator 420 may be trained to predict a recovery pose for escaping from a deadlock state. Diagram 910 illustrates various pose paths for performing the same task. Each pose path may be generated based on demonstration data of an expert who successfully performs a given task. For example, for a task of gripping a green cube, a robotic arm may complete the task through various paths and the paths may be used as training data.

During the training process, the pose path may be reversed starting from a time point at which the task is completed and returning to an initial position. Through this, time series data may be generated to predict the recovery pose. The generated time series data may be trained using Gaussian processes (GPS). The GPs may be effective in modeling a probability distribution of consecutive data and the time series data related to a task pose may be represented by multivariate GPs.

In a diagram 920, the features and limitations of multivariate GPs are illustrated. The multivariate GPs may represent data when a dimension of an operation is at least 6 dimensions (e.g., 6 DoF). As the number of dimensions increase, the computational complexity may exponentially increase. To resolve this problem, an example conditional neural process (CNP) that approximates the multivariate GPs to a neural network may be employed. The CNP may be an efficient model for learning a conditional distribution and may learn a conditional distribution targeting a recovery pose conditioned on a current deadlock state pose (a fallback pose) and embedding on a task instruction extracted from CLIP.

During the learning process, the fallback pose may be generated by adding noise to the current pose. For example, the training data may be diversified by adding a small amount of position and direction noise to a current pose of a task device. The recovery pose may be defined as a pose in a previous time step at a current time step and this may be represented by the conditional distribution to be learned.

Diagram 930 illustrates a mathematical representation of a training process of the recovery pose distribution estimator. In an example, the CNP may learn the conditional distribution according to Equation 1 shown below.

$$GPs ( m ( \cdot ) , k ( \cdot ) ) \approx {p}_{θ} ( {a}_{r} \vert {e}_{τ} , {a}_{c} ) \qquad Equation 1$$

In Equation 1, aᵣ may denote a recovery pose, aϵ may denote a fallback pose, eᵣ may denote embedding extracted from an encoder (e.g., CLIP), and τ may denote a task instruction. The training may be performed through a loss function L(θ) that maximizes log-likelihood. The loss function L(θ) may be expressed by Equation 2.

$$L ( θ ) = - E [ {\sum }_{{ξ}_{i} ∈ D} {\sum }_{j ∈ {ξ}_{i}} log {p}_{θ} ( {a}_{τ}^{j} \vert {e}_{τ} , {a}_{c}^{j} ) ] \qquad Equation 2$$

The loss function in Equation 2 may be used to train the recovery pose distribution estimator and may indicate a training goal of a model to predict a correct recovery pose based on the given data. The loss function may be constituted by samples representing various task instructions (e.g., various cases in which a robot performs a specific task) included in a training data set. Each task may include action data performed over multiple time steps and through this, a model may learn a recovery pose in various circumstances.

More specifically, the loss function may calculate a log value of a conditional probability

$${p}_{θ} ( {a}_{τ}^{j} \vert {e}_{T} , {a}_{c}^{j} ) .$$

returned by the model and may aggregate the log value for all samples of the training data. The reason for using logs may be to prevent a calculation error that may occur when a probability value is significantly small and to simplify the calculation by converting a multiplication operation into an add operation. During the training process, the model may be optimized to maximize log-likelihood, and for this, the loss function may be minimized including a negative sign.

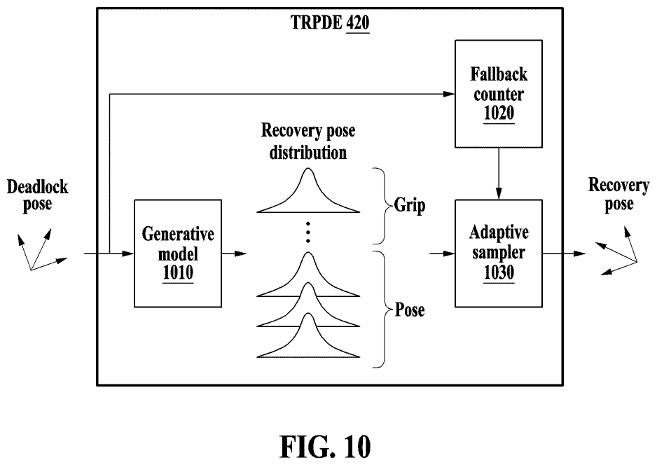

FIG. 10 illustrates an example trained recovery pose estimator according to one or more embodiments. The description provided with reference to FIGS. 1 to 9 may apply to FIG. 10.

Referring to FIG. 10, in a non-limiting example, the recovery pose distribution estimator 420 may include a generative model 1010, a fallback counter 1020, and an adaptive sampler 1030. However, not all components illustrated in the drawings may necessarily be included in additional examples. For example, the recovery pose distribution estimator 420 may be implemented by more components than the illustrated components, and the recovery pose distribution estimator 420 may be implemented by fewer components.

When a deadlock pose is provided as an input, the generative model 1010 may output a recovery pose distribution based upon the deadlock pose. The recovery pose distribution may represent a probability distribution of possible recovery poses for escaping from a deadlock state according to the deadlock pose.

The generated recovery pose distribution may include various poses and, specifically, may include a distribution representing a state of an end effector (an open/close state), such as grip. A grip distribution may represent a probability distribution of manipulable recovery poses depending on a gripper state (e.g., an open state or a closed state) of the end effector. Through this, a recovery pose including not only a position of the end effector but also a state change of the end effector, such as gripping and releasing an object, may be determined.

In an example, the adaptive sampler 1030 may be used to select a single recovery pose to be actually used. The adaptive sampler 1030 may provide an effective method of escaping from the deadlock state by considering various recovery poses rather than simply selecting a pose with the highest probability. Specifically, the adaptive sampler 1030 may also use an output value of the fallback counter 1020 as an input. The fallback counter 1020 may accumulate and record a count of executions of the fallback loop to escape from the current deadlock state.

As a value of the fallback counter 1020 increases, the adaptive sampler 1030 may increase the probability of sampling a value that is farther from a mean value of the recovery pose distribution. This may allow the adaptive sampler 1030 to find various recovery paths by providing an opportunity to try a new pose other than the previous recovery pose when, for example, the end effector remains in the deadlock state. This approach may propose an effective method of escaping from the deadlock state by adaptively utilizing various poses according to the circumstance rather than relying on a specific recovery pose.

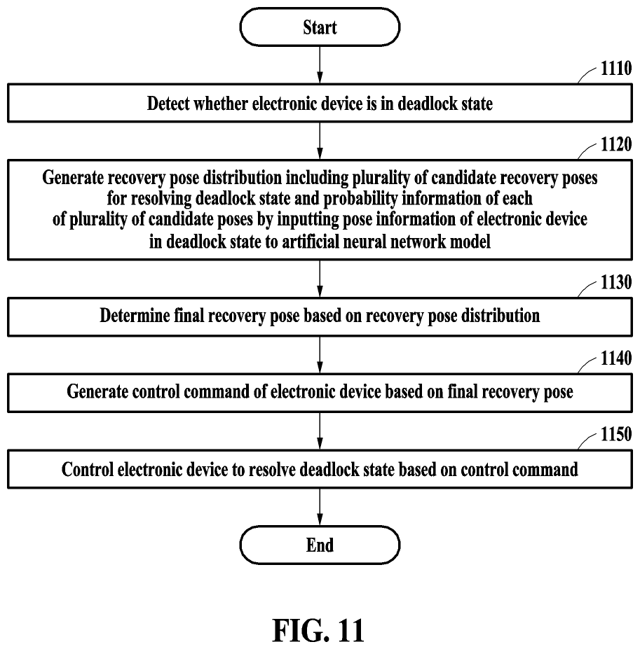

FIG. 11 illustrates an example method with an electronic device according to one or more embodiments. The description provided with reference to FIGS. 1 to 10 may apply to FIG. 11.

For ease of description, it is described that operations 1110 to 1150 are performed by the electronic device (e.g., robotic arm 100) described with reference to FIGS. 1 to 10. However, operations 1110 to 1150 may be used by any other appropriate electronic device or in any appropriate system.

Furthermore, operations may be performed in the sequence and manner as illustrated in FIG. 11. However, the order of some operations may be changed, or some of the operations may be omitted, without departing from the spirit and scope of the illustrative examples described. The operations shown in FIG. 11 may be performed in parallel or simultaneously.

Referring to FIG. 11, in a non-limiting example, in operation 1110, an electronic device (e.g., a robotic arm 100) may detect whether the electronic device is in a deadlock state. The electronic device may determine whether the electronic device is in the deadlock state based on an operation constraint of the electronic device and a preset task constraint. The operation constraint of the electronic device may include a case in which a force applied to a driving part of the electronic device or an operating range exceeds a preset limit and a case in which the electronic device fails to move to a predicted position within a tolerance. The task constraint may include a case in which an operation of the electronic device violates preset conditions such as a predetermined safety constraint and when a task execution time exceeds a preset maximum time.

In an example, in operation 1120, the electronic device may input pose information of the electronic device in the deadlock state to an artificial neural network model which may generate a plurality of candidate poses for resolving the deadlock state and a recovery pose distribution including probability information of each of the plurality of candidate poses. The electronic device may generate the recovery pose distribution by inputting the pose information of the electronic device and a task instruction to the artificial neural network model.

In an example, the artificial neural network model may include a model trained to generate the recovery pose distribution by receiving the pose information of the electronic device in the deadlock state and the task instruction as inputs, based on a CNP that approximates the probability distribution of multivariate GP (MGP).

The pose information of the electronic device may include 6 DoF pose information of the electronic device including a position, a direction, and a rotational axis of an end effector of the electronic device.

In an example, in operation 1130, the electronic device may determine a final recovery pose based on the recovery pose distribution. The electronic device may input the recovery pose distribution to a sampler and the sampler may select a recovery pose with the highest probability from the plurality of candidate recovery poses according to the recovery pose distribution or a pose selected based on a preset condition to be the final recovery pose. The sampler according to an embodiment may include the adaptive sampler described with reference to FIG. 10.

When the deadlock state is not resolved as a result of performing the final recovery pose, the electronic device may record a failure count using a fallback counter (e.g., fallback counter 1020). The electronic device may select the final recovery pose based on the recovery pose distribution and the failure count.

In an example, in operation 1140, the electronic device may generate a control command of the electronic device based on the final recovery pose.

In an example, in operation 1150, the electronic device may control the electronic device to resolve the deadlock state based on the control command.

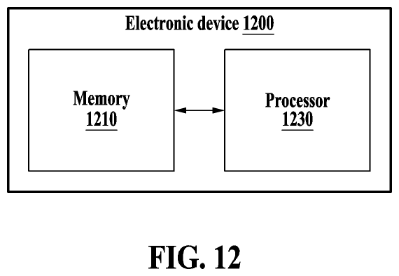

FIG. 12 illustrates an example electronic device according to one or more embodiments. The description provided with reference to FIGS. 1 to 8 may apply to FIG. 12.

Referring to FIG. 12, in a non-limiting example, an electronic device 1200 may include a memory 1210 and a processor 1230. The electronic device 1200 may be a device for resolving a deadlock state and resuming a task in various work environments, such as a robotic arm, a waking assist device (WAD), a drone, an autonomous vehicle, a surgical robot, a warehouse automation robot, construction equipment, a space exploration robot, a domestic robot, an agricultural robot, or an environmental purification robot, and may include a component for predicting an optimal recovery pose based on a task instruction and performing the same.

The memory 1210 may include computer-readable instructions. The processor 1230 may be configured to execute computer-readable instructions, such as those stored in the memory 1210, and through execution of the computer-readable instructions, the processor 1230 is configured to perform one or more, or any combination, of the operations and/or methods described herein. The memory 1210 may be a volatile or nonvolatile memory.

The processor 1230 may be configured to execute programs or applications to configure the processor 1230 to control the electronic apparatus 1200 to perform one or more or all operations and/or methods involving the resolution of a deadlock state and resuming a task, and may include any one or a combination of two or more of, for example, a central processing unit (CPU), a graphic processing unit (GPU), a neural processing unit (NPU) and tensor processing units (TPUs), but is not limited to the above-described examples.

The processor 1230 may be configured to detect whether the electronic device is in a deadlock state, generate a plurality of candidate poses for resolving the deadlock state and a recovery pose distribution including probability information of each of the plurality of candidate poses by inputting pose information of the electronic device in the deadlock state to an artificial neural network model, determine a final recovery pose based on the recovery pose distribution, generate a control command of the electronic device based on the final recovery pose, and control the electronic device to resolve the deadlock state based on the control command. The processor 1230 may perform the operations described with reference to FIGS. 1 to 11 in substantially the same manner. Accordingly, a detailed description is omitted.

The electronic devices, robots, neural networks, processors, memories, robotic arm 100, controller 220, next pose predictor 210, encoder 211, transformer network 212, decoder 213, failure detector 410, recover pose distribution estimator 420, preprocessing processing element 710, generative model 1010, fallback counter 1020, adaptive sample 1030, electronic device 1200, memory 1210, and processor 1230 described herein and disclosed herein described with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
detecting whether an electronic device is in a deadlock state;
generating a plurality of candidate recovery poses for resolving the deadlock state by inputting pose information of the electronic device in the deadlock state to an artificial neural network model;
generating a recovery pose distribution, the recovery pose distribution including respective probability information of each of the plurality of candidate recovery poses;
determining a final recovery pose based on the recovery pose distribution;
generating a control command of the electronic device based on the final recovery pose; and
controlling the electronic device to resolve the deadlock state based on the control command.

2. The method of claim 1, wherein the generating of the recovery pose distribution comprises generating the recovery pose distribution by inputting the pose information of the electronic device and a task instruction to the artificial neural network model.

3. The method of claim 1, wherein the determining of the final recovery pose comprises:
inputting the recovery pose distribution to a sampler; and
selecting, by the sampler, a recovery pose with a highest probability from the plurality of candidate recovery poses according to the recovery pose distribution to be the final recovery pose.

4. The method of claim 1, wherein the determining of the final recovery pose comprises:
inputting the recovery pose distribution to a sampler; and
selecting, by the sampler, a recovery pose based on a preset condition to be the final recovery pose.

5. The method of claim 1, wherein the determining of the final recovery pose comprises, when the deadlock state is not resolved as a result of performing the final recovery pose, recording a failure count using a fallback counter.

6. The method of claim 5, wherein the determining of the final recovery pose further comprises selecting the final recovery pose based on the recovery pose distribution and the failure count.

7. The method of claim 1, wherein the artificial neural network model comprises a model trained to generate the recovery pose distribution using the pose information of the electronic device in the deadlock state and a task instruction as inputs.

8. The method of claim 7, wherein the artificial neural network model is based on a conditional neural process (CNP) configured to calculate a probability distribution of multivariate Gaussian processes (MGPs).

9. The method of claim 1, wherein the detecting of whether the electronic device is in the deadlock state comprises:
determining whether the electronic device is in the deadlock state based on detecting one of an operation constraint of the electronic device and a preset task constraint.

10. The method of claim 9, wherein the operation constraint includes one or more of a first case in which a force applied to a driving part of the electronic device exceeds a first preset limit, a second case in which an operating range of the electronic device exceeds a first preset limit, and a third case in which the electronic device fails to move to a predicted position within a tolerance limit, and
wherein the preset task constraint includes a fourth case in which an operation of the electronic device violates a predetermined safety constraint and a fifth case in which a task execution time exceeds a preset maximum time.

11. The method of claim 1, wherein the pose information of the electronic device comprises 6 degrees of freedom (DoF) pose information of the electronic device and a position, a direction, and a rotational axis of an end effector of the electronic device.

12. An electronic device, comprising:
processors configured to execute instructions; and
a memory storing the instructions, wherein execution of the instructions configures the processors to:
detect whether the electronic device is in a deadlock state; generate a plurality of candidate recovery poses for resolving the deadlock state by inputting pose information of the electronic device in the deadlock state to an artificial neural network model;
generate a recovery pose distribution, the recovery pose distribution including respective probability information of each of the plurality of candidate recovery poses;
determine a final recovery pose based on the recovery pose distribution;
generate a control command of the electronic device based on the final recovery pose; and
control the electronic device to resolve the deadlock state based on the control command.

13. The electronic device of claim 12, wherein the processors are further configured to:
generate the recovery pose distribution by inputting the pose information of the electronic device and a task instruction to the artificial neural network model.

14. The electronic device of claim 12, wherein the processors are further configured to:
select a recovery pose with a highest probability from the plurality of candidate recovery poses according to the recovery pose distribution to be the final recovery pose.

15. The electronic device of claim 12, wherein the processors are further configured to:
when the deadlock state is not resolved as a result of performing the final recovery pose, record a failure count.

16. The electronic device of claim 15, wherein processors are further configured to:
select the final recovery pose based on the recovery pose distribution and the failure count.

17. The electronic device of claim 12, wherein the artificial neural network model comprises a model trained to generate the recovery pose distribution using the pose information of the electronic device in the deadlock state and a task instruction as inputs.

18. The electronic device of claim 12, wherein processors are further configured to:
determine whether the electronic device is in the deadlock state based on detecting one of an operation constraint of the electronic device and a preset task constraint.

19. The electronic device of claim 18, wherein the operation constraint includes one or more of a first case in which a force applied to a driving part of the electronic device exceeds a first preset limit, a second case in which an operating range of the electronic device exceeds a first preset limit, and a third case in which the electronic device fails to move to a predicted position within a tolerance limit, and
wherein the preset task constraint includes a fourth case in which an operation of the electronic device violates a predetermined safety constraint and a fifth case in which a task execution time exceeds a preset maximum time.

20. The electronic device of claim 12, wherein the electronic device comprises a robotic arm, and
wherein the pose information of the electronic device comprises 6 degrees of freedom (DoF) pose information of the robotic arm and a position, a direction, and a rotational axis of an end effector of the robotic arm.
